(19) United States
(12) Patent Application Publication
(10) Pub. No.: US 2002/0118714 A1
(43) Pub. Date: Aug. 29, 2002

(54) Heat sink, semiconductor laser device, semiconductor laser module and raman amplifier

(75) Inventors: Sadayoshi Kanamaru, Chiyoda-ku (JP); Toshio Kimura, Chiyoda-ku (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD, Tokyo (JP)

(21) Appl. No.: 09/984,142

(22) Filed: Oct. 29, 2001

(30) Foreign Application Priority Data
Oct. 27, 2000 (JP) 2000-329731

(51) Int. Cl. H01S 3/04

(52) U.S. Cl. 372/36

(57) ABSTRACT

At least one bevel is formed on the top of a heat sink on which a semiconductor laser diode is placed, the bevel being sloped from either side of first or second optical system downwardly toward the bottom of the heat sink. Thus, the heat radiation area of the heat sink can be increased without blocking of the laser beam emitted from the semiconductor laser diode and without engagement of the heat sink with the first and second optical systems. As a result, the optical output of a semiconductor laser module using such a semiconductor laser diode can be increased. The semiconductor laser module can be applied to even a pump light source used in Raman amplification and required to have a high-power.

### BACKGROUND OF THE INVENTION

The present invention relates to a heat sink, semiconductor laser device, semiconductor laser module and Raman amplifier.

In the field of semiconductor laser module used in the pump light source of an optical amplifier, it is broadly known that a fiber bragg grating (FBG) is provided in the interior of an optical fiber (or pigtail fiber) which is optically coupled with a laser beam emitted from the front facet of a semiconductor laser diode. Such a fiber bragg grating is used in an external resonator to control the oscillating wavelength into a wavelength determined by the fiber bragg grating.

Such a type of semiconductor laser module is used, for example, as the pump light source of the Raman amplifier. Raman amplification is a process of amplifying an optical signal by using such a phenomenon that the induced Raman scattering produced when a pump beam enters the optical fiber creates a gain on the low-frequency side lower than the frequency of the pump beam by about 13 THz and that when a signal beam of a wavelength range having such a gain is inputted into the optical fiber in such pumped state, that signal beam is amplified. The Raman amplification is characterized by:

(1) that the existing optical fiber can be used as amplifying medium, rather than any special fiber such as erbium-doped fiber; and

(2) that when the wavelength of the pump beam entering the optical fiber is changed, the amplification gain can be obtained at any wavelength, thereby increasing the number of signal beam channels in WDM (Wavelength Division Multiplexing).

On the contrary, the Raman amplification is required to have its optical output higher than about 300 mW toward the semiconductor laser module since the resultant gain is smaller. The Raman amplification is further required to stabilize the wavelength through the fiber bragg grating or the like and to reduce noise in the pump beam since the variations of the oscillating wavelength vary the gain wavelength range.

### SUMMARY OF THE INVENTION

The present invention provides a heat sink on the top of which a semiconductor laser diode is placed, comprising at least one bevel formed on said top to extending downwardly toward the bottom of said heat sink.

The present invention also provides a semiconductor laser device comprising:

a semiconductor laser diode for emitting a laser beam, said semiconductor laser diode having first and second beam emission facets;

a heat sink on the top of which said semiconductor laser diode is placed; and

at least one bevel formed on the top of said heat sink, said bevel being sloped downwardly toward the bottom of said heat sink on either side of the first or second beam emission facet in said semiconductor laser diode.

The present invention also provides a semiconductor laser module comprising:

a semiconductor laser device including a semiconductor laser diode for emitting a laser beam and having first and second beam emission facets and a heat sink on the top of which said semiconductor laser diode is placed, the top of said heat sink including at least one bevel formed therein on either side of the first or second beam emission facet in said semiconductor laser diode, said bevel being sloped downwardly toward the bottom of said heat sink; and

an optical system for receiving the laser beam emitted from either of the first or second beam emission facet in the semiconductor laser diode on said semiconductor laser device.

The present invention further provides a Raman amplifier comprising:

a semiconductor laser modules each including a semiconductor laser device, said semiconductor laser device including a semiconductor laser diode having first and second beam emission facets for emitting laser beams and a heat sink on the top of which said semiconductor laser diode is placed, said heat sink including at least one bevel formed on the top of said heat sink on either side of the first or second beam emission facet in said semiconductor laser diode, said bevel being sloped downwardly toward the bottom of said heat sink, and an optical system for receiving a laser beam emitted from either of the first or second beam emission facet in the semiconductor laser diode on said semiconductor laser device; and

an optical fiber for transmitting a signal beam, said optical fiber being adapted to combine pump beams emitted from said semiconductor laser modules with the signal beam transmitted through said optical fiber.

### BRIEF DESCRIPTION OF THE DRAWINGS

FIGS. 1A-D schematically illustrate several different forms of a semiconductor laser module constructed according to the present invention.

FIGS. 2A and B are perspective and plan views of a semiconductor laser device constructed according to the present invention.

FIGS. 3A and B are perspective and plan views of another semiconductor laser device constructed according to the present invention.

FIG. 4 illustrates the angle of a bevel formed in a heat sink: FIG. 4A showing a case where lenses are disposed opposed to each other about a semiconductor laser diode; FIG. 4B showing another case where lensed fibers are disposed opposed to each other about the semiconductor laser diode; and FIG. 4C being a graph illustrating an angle of divergence θ₁ in the laser beam.

FIG. 5 is a cross-sectional view of a semiconductor laser module constructed according to the present invention.

FIG. 6 is a block diagram of a Raman amplifier constructed according to the present invention.

FIG. 7 is a diagrammatically cross-sectional view of a semiconductor laser module constructed according to the prior art.

### DETAILED DESCRIPTION

Several embodiments of the present invention will now be described in comparison with the prior art with reference to the drawings.

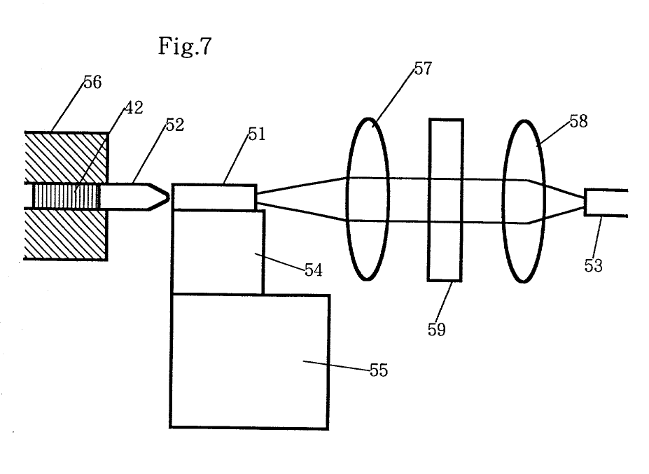

As one of the conventional techniques for reducing noise in a signal light source, for example, Japanese Patent Laid-Open Application No. Hei 12-208869 has proposed a semiconductor laser module in which an optical fiber lensed at its tip end and having FBG is disposed behind a semiconductor laser diode to reduce the distance between the semiconductor laser diode and FBG. FIG. 7 is a diagrammatically cross-sectional view of such a semiconductor laser module according to the prior art.

Referring to FIG. 7, the semiconductor laser module of the prior art comprises a semiconductor laser diode 51 for emitting a laser beam, a first optical fiber 52 for receiving the laser beam emitted from the back facet (left side in FIG. 7) of the semiconductor laser diode 51, the first optical fiber 52 including a diffraction grating 42 such as FBG, and a second optical fiber 53 for receiving thee laser beam emitted from the front facet (right side in FIG. 7) of the semiconductor laser diode 51. These components are housed within a package.

The semiconductor laser diode 51 is fixedly mounted on a heat sink 54 which is in turn fixedly mounted on a chip carrier 55.

The first optical fiber 52 is a lensed fiber in which the tip end facing the semiconductor laser diode 51 is lensed and which is inserted into and supported by a first ferrule 56. At this time, the first optical fiber 52 is positioned relative to the semiconductor laser diode 51 such that the tip end of the first optical fiber 52 is located opposed to the back facet of the semiconductor laser diode 51, and more particularly, such that the diffraction grating 42 of the first optical fiber 52 is located opposed to the active layer end of the semiconductor laser diode 51. In such an arrangement, an optical resonance will be created between the front facet of the semiconductor laser diode 51 and the diffraction grating 42 of the first optical fiber 52 through the active layer of the semiconductor laser diode 51. Thus, the laser beam will be emitted from the front facet of the semiconductor laser diode 51.

A cooling device (not shown) consisting of Peltier device is located below the chip carrier 55 and adapted to cool the semiconductor laser diode 51 and first optical fiber 52.

In front of the semiconductor laser diode 51, there are fixedly located a first lens (collimating lens) 57 for collimating the laser beam emitted from the front facet of the semiconductor laser diode 51 and a second lens 58 for condensing the collimated laser beam into the second optical fiber 53.

The second optical fiber 53 is disposed, at its tip end, opposed to the front facet of the semiconductor laser diode 51 and adapted to deliver the laser beam from the front facet of the semiconductor laser diode toward any optical element outside of the package.

Between first and second lenses 57, 58, there is disposed an optical isolator 59 for selectively transmitting the laser beam traveling from the front facet of the semiconductor laser diode 51 toward the tip end of the second optical fiber 53.

As shown in FIG. 7, the heat sink 54 of the prior art is of substantially rectangular configuration and designed to have its length substantially slightly longer than the length of the semiconductor laser diode 51 in the direction of emission such that the laser beam emitted from the front facet of the semiconductor laser diode 51 will not be blocked before it reaches the first lens 57 and also such that the heat sink 54 will not be engaged by the first optical fiber 52 disposed behind the semiconductor laser diode 51.

Thus, the heat sink 54 of the prior art has less heat radiation area for radiating heat from the semiconductor laser diode 51. Heat tends to be accumulated in the place in which the semiconductor laser diode 51 is installed. This impedes the increase of power in the semiconductor laser diode 51.

Therefore, the prior art could only provide a lower output since the heat could not effectively be radiated from the semiconductor laser diode 51. It is thus difficult to apply the semiconductor laser diode to the pump light source for the Raman amplification that requires the power higher than about 300 mW.

The present invention provides a heat sink, semiconductor laser device, semiconductor laser module and Raman amplifier which can effectively radiate heat from the semiconductor laser diode.

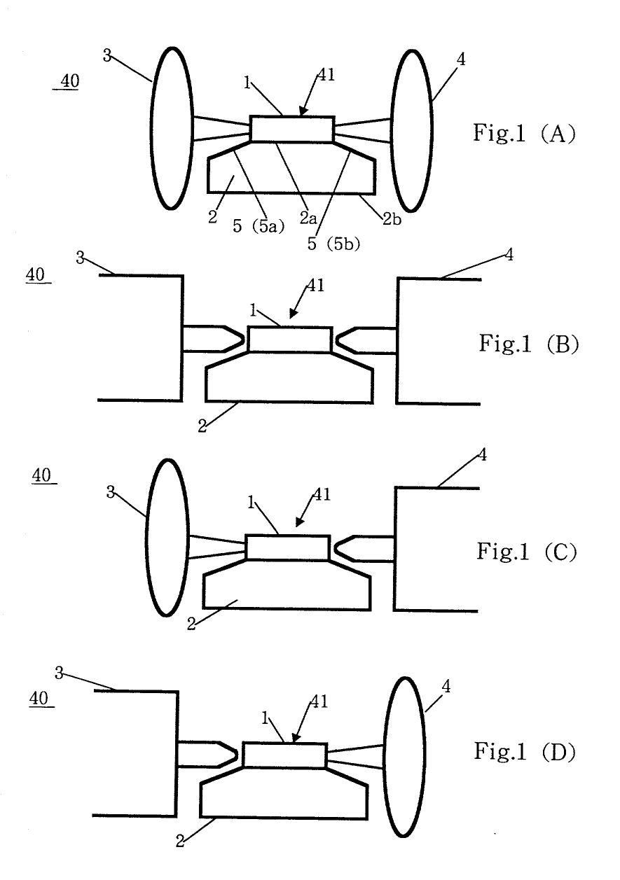

FIGS. 1A-D schematically illustrate several different forms of a semiconductor laser module according to the present invention.

Referring to FIG. 1, a semiconductor laser device 41 comprises a semiconductor laser device 1 for emitting a laser beam, and a heat sink 2 on the top of which the semiconductor laser diode 1 is placed. The heat sink 2 is formed of AlN (aluminum nitride), diamond or the like.

A semiconductor laser module 40 comprises the aforementioned semiconductor laser device 41, a first optical system 3 for receiving the laser beam emitted from one facet of the semiconductor laser diode 1 and a second optical system 4 for receiving the laser beam emitted from the other facet of the semiconductor laser diode 1. The first and second optical systems 3, 4 are disposed opposed to each other about the semiconductor laser diode 1.

The top face 2a of the heat sink 2 includes bevels 5 formed thereon each of which is sloped from the corresponding edge of the portion on which the semiconductor laser diode is placed toward the bottom face 2b. The bevels 5 includes a first beveled portion 5a sloped toward the side of the first optical system 3 and a second beveled portion 5b sloped toward the side of the second optical system 4.

The first or second optical system (3 or 4) may be provided on only one of the opposite sides of the semiconductor laser diode 1 while only one of the bevels 5 may be formed on the heat sink 2 for either of the optical systems. If an optical fiber is coupled with the front side of the semiconductor laser diode 1 through an optical system and a monitoring photodiode is disposed behind the semiconductor laser diode without interposition an optical system, one of the bevels 5 may be formed only on the front side of the heat sink.

Each of the first and second optical systems 3, 4 is a discrete lens or an optical fiber having its tip end in which a lens is formed (lensed fiber). For example, both the first and second optical systems 3, 4 may be in the form of discrete lens (see FIG. 1A); both the first and second optical systems 3, 4 may be in the form of lensed fiber (see FIG. 1B); the first optical system 3 may be a discrete lens while the second optical system 4 may be a lensed fiber (see FIG. 1C); and the first optical system 3 may be a lensed fiber while the second optical system 4 may be a discrete lens (see FIG. 1D).

According to the present invention, the top face 2a of the heat sink 2 on which the semiconductor laser diode 1 is placed includes the bevels 5 formed thereon such that they are sloped from the opposite edge portions of the heat sink 2 on which the semiconductor laser diode is placed toward the bottom face 2b of the heat sink 2 adjacent to the first and second optical systems 3, 4. Therefore, the heat radiation area of the heat sink 2 can be increased without interruption of the laser beam from the semiconductor laser diode 1 and without being engaged by the first and second optical systems 3, 4. As a result, the heat radiation of the semiconductor laser diode 1 can be improved to increase the optical power in the semiconductor laser module 40. Even though a high-power higher than about 300 mW is required as in the pump light source for Raman amplification, the semiconductor laser module 40 according to the present invention can be used.

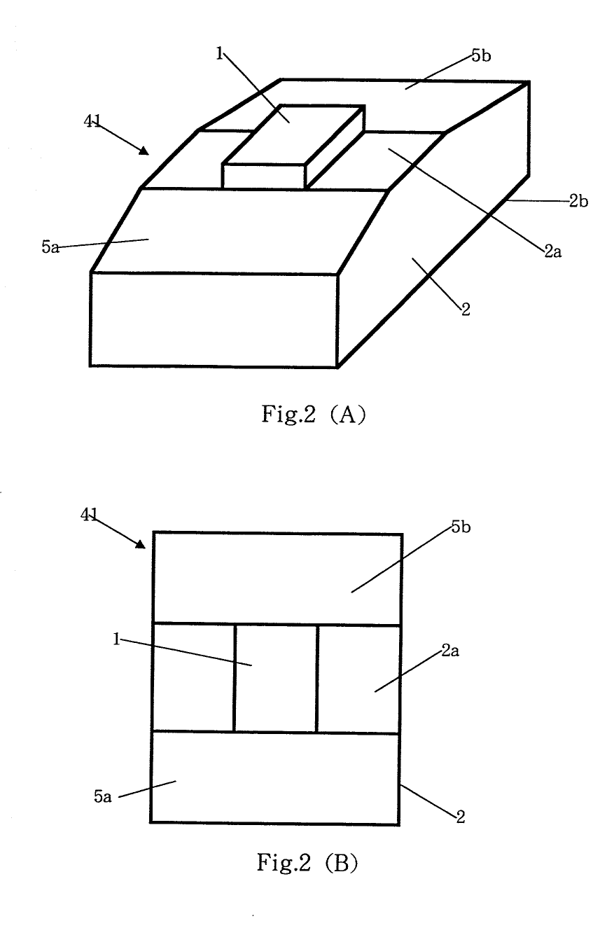

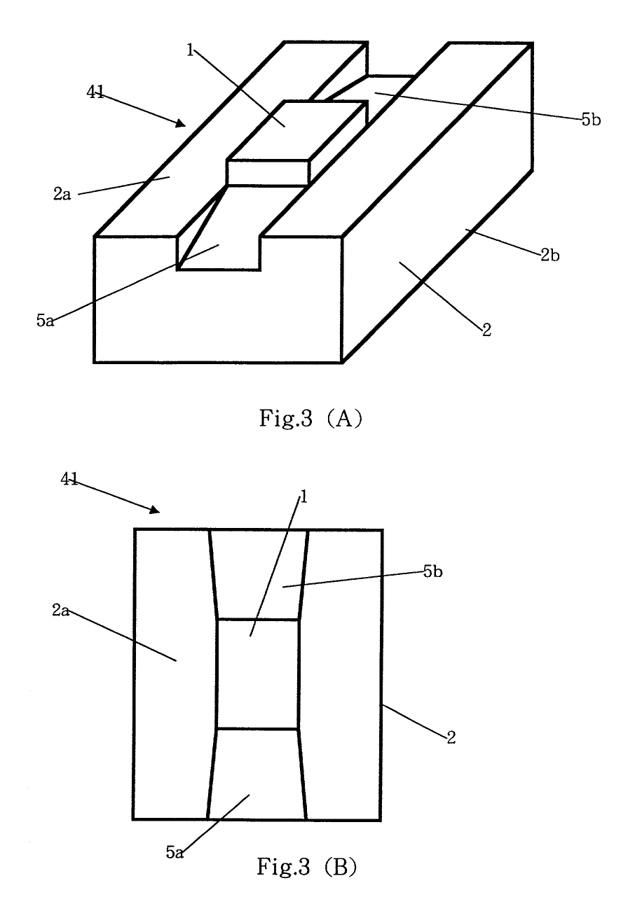

FIGS. 2 and 3 show several different forms of the semiconductor laser device 41 according to the present invention.

The heat sink 2 used for the semiconductor laser device 41 according to the present invention may be of substantially trapezoidal cross-section, as shown in FIGS. 2A and B. The first and second beveled portions 5a, 5b extend downwardly from the opposite edges of the top face 2a of the heat sink 2, respectively.

The heat sink 2 may be of rectangular parallelopiped configuration, as shown in FIGS. 3A and B. Grooves are formed on the top face 2a of the heat sink 2 to extend from the heat sink portion on which the semiconductor laser diode is placed in the opposite directions. Each of these grooves has first or second downwardly beveled portion (5a or 5b) formed therein. In this case, Since the remaining part of the top heat sink face 2a is flat facing the direction of emission, the heat radiation area will be increased to further improve the efficiency of heat radiation.

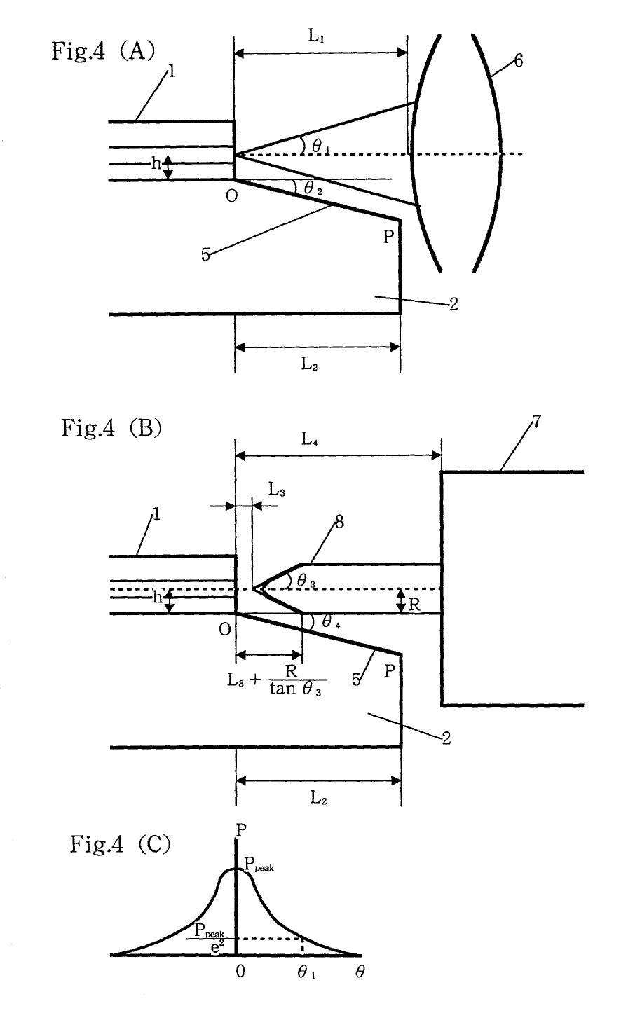

FIG. 4 illustrates the angle in the bevels 5 formed in the heat sink 2. FIG. 4A shows a case where a lens 6 is disposed opposed to the semiconductor laser diode 1. In this figure, L₁ represents the distance between the emission facet of the semiconductor laser diode 1 and the lens 6; L₂ the width across which the heat sink 2 extends outwardly; h the height from the top of the heat sink 2 to the laser beam emission point; θ₁ one-half of the angle of divergence in the laser beam; and θ₂ the angle of each bevel 5 in the heat sink 2.

The angles θ₁ and θ₂ may be defined so that θ₁ represents the angle of convergence in the laser beam and θ₂ is the angle of each bevel 5 in the heat sink 2. For example, θ₁ may be defined as an angle at which the value of the power distribution in the far field pattern of the semiconductor laser diode 1 is equal to 1/e² of the peak value Pₚₑₐₖ, as shown in FIG. 4C.

If the first or second optical system (3 or 4) is in the form of the lens 6, the angle θ₂ of each bevel 5 in the heat sink 2 is set depending on the angle of convergence of the laser beam. In other words, if it is wanted not to engage the emission facet of the semiconductor laser diode 1 with the edge P of the heat sink 2 when the end O of the heat sink portion on which the semiconductor laser diode 1 is placed is used as an origin, the following formula should be established:

h−L₂ tan θ₁>−L₂ tan θ₂ (1)

Form the formula (1),

θ₂>tan⁻¹ (tan θ₁−h/L₂) (2)

will be obtained.

Since tan θ₁>>h/L₂ in the conventional semiconductor laser which is fixed to the heat sink through junction down, the formula (2) will be θ₂>θ₁.

For example, where L₁=400 μm, L₂=350 μm, h=10 μm and θ₁=15°, θ₂>13.5°. Therefore, the angle θ₂ may be set at about 20°.

FIG. 4B shows another case where a lensed fiber 8 held by a ferrule 7 is disposed opposed to the semiconductor laser diode 1. In this figure, L₂ indicates the width across which the heat sink 2 extends outwardly; L₃ the distance between an intersection of the inclined lines defining the tip cross-section of the lensed fiber 8 with the optical axis and the emission facet of the semiconductor laser diode 1; L₄ the distance between the emission facet of the semiconductor laser diode 1 and the ferrule 7; R the radius of the lensed fiber 8; h the height from the top of the heat sink 2 to the laser beam emission point; θ₃ the angle of the tip end of the lensed fiber 8 (half-angle); θ₄ the angle of each bevel 5 in the heat sink 2.

If the first or second optical system (3 or 4) is the lensed fiber 8, the angel θ₄ of each bevel 5 in the heat sink is set depending on the angle at the tip end of the lensed fiber 8. In other words, a condition in which the heat sink 2 will not interfere with the lensed fiber 8 is:

h−R>−(L₃+R/tan θ₃) tan θ₄ (3)

in a coordinate system in which the end O of the heat sink portion on which the semiconductor laser diode 1 is placed is an origin. Therefore,

θ₄>tan⁻¹((R−h)/(L₃+R/tan θ₃)) (4)

For example, where L₂=350 μm, L₄=400 μm, L₃=5 μm, R=62.5 μm, h=10 μm and θ₃=30°, θ₄>24.8°. Therefore, the angle θ₄ may be set at about 30°.

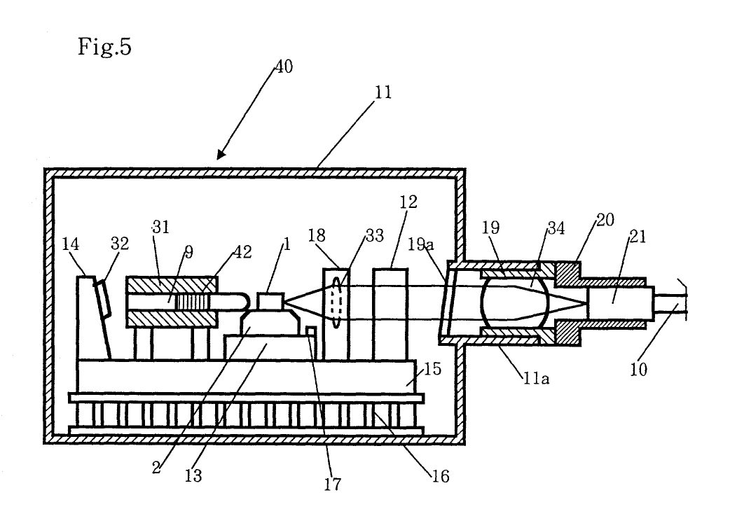

FIG. 5 is a cross-sectional view of a semiconductor laser module according to the present invention. Referring to FIG. 5, the semiconductor laser module 40 comprises a hermetically sealed package 11, a semiconductor laser diode 1 located within the package 1 for emitting a laser beam, a first optical fiber 9 having its lensed tip end and including a diffraction grating 42 for receiving the laser beam emitted from the back facet (left side in FIG. 5) of the semiconductor laser diode 1 and for selectively reflecting the laser beam having a predetermined wavelength range, and a second optical fiber 10 for receiving the laser beam emitted from the front facet (right side in FIG. 5) of the semiconductor laser diode 1 and for externally delivering it.

The semiconductor laser diode 1 is adapted to oscillate at 1200 nm-1550 nm and mounted on a heat sink 2 which is in turn fixedly mounted on a chip carrier 13.

The first optical fiber 9 is held by a ferrule 31 which is disposed behind the semiconductor laser diode 1.

There is also provided a photodiode 32 which is fixedly mounted on a photodiode carrier 14. The chip carrier 13 and photodiode carrier 14 are mounted on a base 15, below which a cooling device 16 consisting of Peltier device is located. Any raised temperature due to heat from the semiconductor laser diode 1 is sensed by a thermistor 17 which is placed on the chip carrier 13. The temperature sensed by the thermistor 17 is controlled by the cooling device 16 such that it can be maintained constant. Thus, the laser output of the semiconductor laser diode 1 can be stabilized.

A first lens 33 for collimating the laser beam from the semiconductor laser diode 1 is disposed in front of the semiconductor laser diode 1 on the base 15. The first lens 33 is held by a first lens holder 18 on the base 5.

The package 11 includes, at one side, a flange 1 a formed thereon. The flange 11a includes a window 19a for receiving the beam after passed through the first lens 33 and a second lens 34 for condensing the laser beam. The second lens 34 is held by a second lens holder 19 which is fixedly mounted on one end of the flange 11a through YAG welding. On the outer end of the second lens holder 19 is fixedly mounted a metallic slide ring 20 through YAG laser welding. After the slide ring 20 has been positioned in a plane perpendicular to the optical axis of the optical fiber 10 (X-Y plane), the slide ring 20 is YAG welded to the end of the second lens holder 19 at the boundary.

The second optical fiber 10 is held by a ferrule 21 which is in turn fixedly mounted in the interior of the slide ring 20 through YAG laser welding. Thus, the optical fiber 3 will be positioned in the direction of optical axis (Z-axis direction).

Between the semiconductor laser diode 1 and the second optical fiber 10 is located an optical isolator 12 for blocking any reflective beam returned from the second optical fiber 10.

Since the first optical fiber 9 having the diffraction grating 42 is disposed between the semiconductor laser diode 1 and the photodiode 32, an optical resonance occurs between the front facet of the semiconductor laser diode 1 and the diffraction grating 42 of the first optical fiber 9, thereby causing a laser beam having a predetermined wavelength to emit from the front facet of the semiconductor laser diode 1. The laser beam emitted from the front facet of the semiconductor laser diode 1 is collimated by the first lens 33 and condensed by the second lens 34 through the optical isolator 12 into the end of the second optical fiber 10 held by the ferrule 21. Thereafter, the laser beam will externally be delivered.

On the other hand, the monitoring laser beam emitted from the back facet of the semiconductor laser diode 1 is received by the photodiode 32 through the first optical fiber 9. By calculating the amount of received beam at the photodiode, the optical output and others of the semiconductor laser diode 1 are regulated.

The optical system for optically coupling the laser beam from the front facet of the semiconductor laser diode 1 with the optical fiber 10 is not limited to such two-lens system as described, but may be in the form of condensing one-lens system.

The semiconductor laser module 40 according to the present invention can improve the efficiency of heat radiation in the semiconductor laser diode 1 by the use of the heat sink 2 having the bevels 5 to increase the optical output. Since the diffraction grating 42 is provided in the semiconductor laser module 4 and the first optical fiber 9 having its lensed tip is disposed behind the semiconductor laser diode 1, the spacing between the semiconductor laser diode 1 and the diffraction grating 42 can greatly be reduced. This reduces noise in the laser beam emitted from the semiconductor laser diode 1. Namely, the RIN characteristic is improved.

Since the optical isolator 12 for blocking the reflective beam returned from the second optical fiber 10 can be inserted between the semiconductor laser diode 1 and the second optical fiber 10, the semiconductor laser diode 1 can be operated in a more stable manner.

From these advantages, the semiconductor laser module 40 shown in FIG. 5 can be said that it is highly suitable for use as a pump light source in Raman amplification.

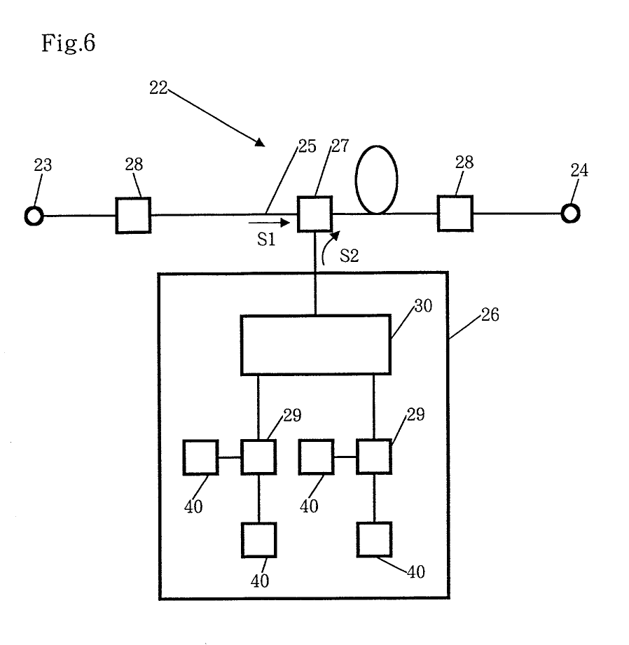

FIG. 6 is a block diagram of a Raman amplifier according to the present invention. Referring to FIG. 6, the Raman amplifier 22 comprises an input portion 23 for receiving a signal beam S1, an output portion 24 for outputting the signal beam S1, an optical fiber 25 for transmitting the signal beam S1 between the input and output portions 23, 24, a pump beam generating portion 26 for generating a pump beam S2, and a WDM coupler 27 for combining the pump beam S2 generated by the pump beam generating portion 26 with the signal beam S1 transmitted toward the optical fiber 25. Optical isolators 28 for transmitting only the signal beam S1 directed from the input portion 23 toward the output portion 24 are located between the input portion 23 and the WDM coupler 27 and between the output portion 24 and the WDM coupler 27, respectively.

The pump beam generating portion 26 comprises the semiconductor laser modules 40 of the present invention described above, polarized-wave combining couplers 29 for cross polarizing and combining the laser beams emitted from the respective semiconductor laser modules 40 and having the same wavelength, and a WDM coupler 30 for combining the output beams from the respective polarized-wave combining couplers 29. The cross polarizing and combining in the polarized-wave combining couplers 29 is to negate the polarized-wave dependency in the Raman amplification gain by reducing the degree of polarization (DOP) and to provide a higher output through the combining.

The pump beams S2 emitted from the semiconductor laser modules 40 and having the same wavelength are polarized-wave combined by the respective polarized-wave combining couplers 29. The output beams from the respective polarized-wave combining couplers 29 are combined by the WDM coupler 30 and then outputted from the pump beam generating portion 26.

The pump beam S2 generated by the pump beam generating portion 26 is coupled with the optical fiber 25 by the WDM coupler 27. When the pump beam S2 travels through the optical fiber 25, it generates Raman gain at the low frequency equal to about 13 THz. When the signal beam inputted from the input portion 23 propagates in the optical fiber 25 at this time, the signal beam will be amplified and then outputted through the output portion 24.

Since the Raman amplifier 22 of the present invention uses the semiconductor laser modules 40 which are superior in heat radiation as pump light sources, the desired Raman gain can be provided by the high-power pump beam S2.

The present invention is not limited to the aforementioned forms, but may changed or modified to various other forms without departing from the spirit and scope of the invention as defined in the appending claims. For example, the bevels 5 may be coated with any suitable non-reflective material in order to prevent the output characteristic of the semiconductor laser module 40 from being changed by the laser beam which is emitted from the semiconductor laser diode 1 and reflected by the bevels 5 into the optical systems 3 and 4.

1. A heat sink on the top of which a semiconductor laser diode is placed, comprising at least one bevel formed on said top to extending downwardly toward the bottom of said heat sink.

2. The heat sink according to claim 1 wherein two of said bevel are formed in the heat sink on the opposite sides about said semiconductor laser diode.

3. A semiconductor laser device comprising:
a semiconductor laser diode for emitting a laser beam, said semiconductor laser diode having first and second beam emission facets;
a heat sink on the top of which said semiconductor laser diode is placed; and
at least one bevel formed on the top of said heat sink, said bevel being sloped downwardly toward the bottom of said heat sink on either side of the first or second beam emission facet in said semiconductor laser diode.

4. The semiconductor laser device according to claim 3 wherein two of said bevel are formed on the heat sink at the opposite sides about said semiconductor laser diode.

5. The semiconductor laser device according to claim 3 wherein said bevel is sloped with such an angle that the laser beam from said semiconductor laser diode will not be blocked by said heat sink.

6. The semiconductor laser device according to claim 3 wherein said bevel is sloped with such an angle that an optical system for receiving the laser beam from said semiconductor laser diode will not be engaged by said heat sink.

7. A semiconductor laser module comprising:
a semiconductor laser device including a semiconductor laser diode for emitting a laser beam and having first and second beam emission facets and a heat sink on the top of which said semiconductor laser diode is placed, the top of said heat sink including at least one bevel formed therein on either side of the first or second beam emission facet in said semiconductor laser diode, said bevel being sloped downwardly toward the bottom of said heat sink; and
an optical system for receiving the laser beam emitted from either of the first or second beam emission facet in the semiconductor laser diode on said semiconductor laser device.

8. The semiconductor laser module according to claim 7 wherein two of said bevel are formed on the heat sink at the opposite sides about said semiconductor laser diode.

9. The semiconductor laser module according to claim 7, further comprising a fiber bragg grating located on the side of the back semiconductor laser diode facet, said fiber bragg grating forming an external resonator together with said semiconductor laser diode; and an optical fiber located on the side of the front semiconductor laser diode facet, said optical fiber being adapted to conduct the laser beam emitted from said semiconductor laser diode.

10. The semiconductor laser module according to claim 7, further comprising a lens formed in said fiber bragg grating at the end thereof opposed to said semiconductor laser diode.

11. A Raman amplifier comprising:
a semiconductor laser modules each including a semiconductor laser device, said semiconductor laser device including a semiconductor laser diode having first and second beam emission facets for emitting laser beams and a heat sink on the top of which said semiconductor laser diode is placed, said heat sink including at least one bevel formed on the top of said heat sink on either side of the first or second beam emission facet in said semiconductor laser diode, said bevel being sloped downwardly toward the bottom of said heat sink, and an optical system for receiving a laser beam emitted from either of the first or second beam emission facet in the semiconductor laser diode on said semiconductor laser device; and
an optical fiber for transmitting a signal beam, said optical fiber being adapted to combine pump beams emitted from said semiconductor laser modules with the signal beam transmitted through said optical fiber.

12. The Raman amplifier according to claim 11 wherein two of said bevel are formed on the heat sink at the opposite sides about said semiconductor laser diode.
